(19) United States
(12) Patent Application Publication
(10) Pub. No.: US 2007/0079030 A1
(43) Pub. Date: Apr. 5, 2007

(54) Auxiliary display and storage unit

(75) Inventors: Jim Okuley, Portland, OR (US); Robert Jacobs, Portland, OR (US); Jim Trethewey, Hillsboro, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/241,648

(22) Filed: Sep. 30, 2005

(51) Int. Cl. G06F 13/38

(52) U.S. Cl. 710/62

(57) ABSTRACT

Apparatus and systems, as well as methods and articles, may operate to receive an indication that a housing having an integrated auxiliary display and a memory forming a portion of a redundant array disk storage has been inserted into a recessed housing compartment of a portable computer having an integrated primary display, and to execute a storage operation using the redundant array disk storage.

### RELATED APPLICATIONS

This disclosure is related to U.S. patent application Ser. No. 09/467,099, titled “Dockable Data Storage Device with Independent Audio Playback”, now abandoned; and pending U.S. patent application Ser. No. 10/367,076, titled “Method and Apparatus for a User to Interface With a Mobile Computing Device”, filed on Feb. 14, 2003. Both applications have been assigned to the assignee of the embodiments disclosed herein, Intel Corporation.

### TECHNICAL FIELD

Various embodiments described herein relate to information processing generally, including apparatus, systems, and methods used to store and display information.

### BACKGROUND INFORMATION

Current portable media players (e.g., digital music and video players) may utilize bulky docking stations and cables to synchronize with desktop or laptop computers, often via applications that are not very user-friendly. Performing regular data backup operations under these circumstances may require mental effort by the user, resulting in habitual failure to do so.

### BRIEF DESCRIPTION OF THE DRAWINGS

FIGS. 1A-1D illustrate apparatus and systems according to various embodiments of the invention.

FIG. 2 is a flow diagram illustrating several methods according to various embodiments of the invention.

FIG. 3 is a block diagram of an article according to various embodiments.

### DETAILED DESCRIPTION

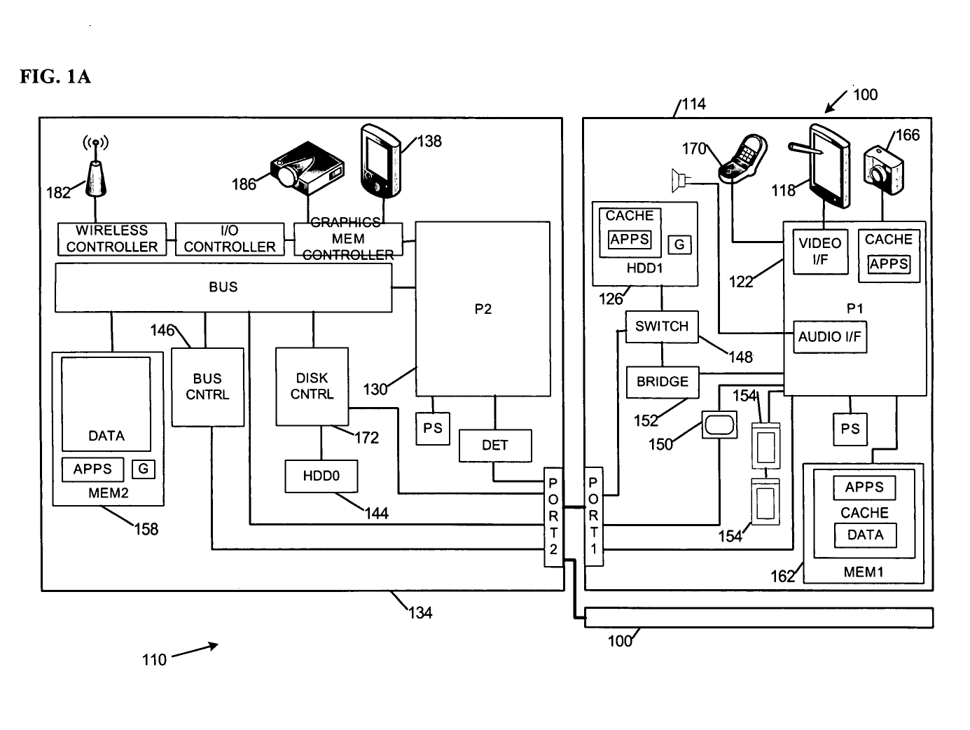

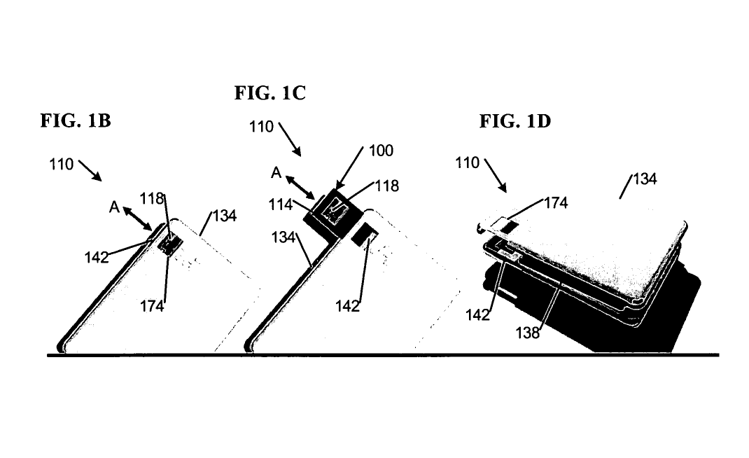

FIGS. 1A-1D illustrate apparatus 100 and systems 110 according to various embodiments of the invention. For example, an apparatus 100 may include a housing 114 having a an integrated auxiliary display 118 coupled to a first processor 122. The apparatus 100 may also include a memory 126 (e.g., a non-volatile memory, including one or more solid state disks, or mechanical disk drives) coupled to the first processor 122 so as to form a portion of a redundant array disk storage, perhaps operating in conformance with a Redundant Array of Independent Disks (RAID) information storage standard.

The apparatus 100 may include a port PORT1 in the housing 114 to couple the first processor 122 to a second processor 130 included in a computer 134, such as a desktop or portable computer (e.g., notebook or laptop computer) having an integrated primary display 138 and a recessed housing compartment 142 to receive the housing 114. The computer 134 may have a memory 144 (e.g., non-volatile memory), including one or more solid state disks, or mechanical disk drives, perhaps forming a portion of a redundant array disk storage, and operating in conformance with a Redundant Array of Independent Disks (RAID) information storage standard.

The first and second processors 122, 130 may be coupled together, either directly via the ports PORT1, PORT2, or indirectly, using the ports PORT1, PORT2 and additional mechanisms, such as a bus BUS and a bus controller 146, including a Universal Serial Bus (USB) controller. For more information regarding the USB, please refer to the Universal Serial Bus Specification Version 2.0 (2000), published by USB-IF; 5440 SW Westgate Drive, Suite 217; Portland, Oreg. 97221, and recent amendments thereto.

The memories 126, 144 may be coupled together, directly, or indirectly, as shown in FIG. 1A. Various coupling mechanisms may be used, including a bus BUS, a drive controller 172, and/or one or more AT Attachment interfaces between the computer 134 and the apparatus 100, such as a serial AT attachment (SATA) switch 148, and/or a SATA bridge 152. For more information regarding the SATA series of standards, please refer to the International Committee for Information Technology Standards (INCITS) Technical Committee T13 AT Attachment storage interface standard “ANSI NCITS 397-2005 AT Attachment-7 with Packet Interface,” published in 2005, and later revisions.

The ports PORT1, PORT2 may comprise one or more of a serial ports (e.g., USB or FireWire), parallel ports (e.g., general purpose interface bus (GPIB) or printer port), wired network interfaces, optical interfaces, or wireless network interfaces, including interfaces operating according to an Institute of Electrical and Electronics Engineers (IEEE) 802.11x standard. For more information regarding the FireWire interface, please refer to the IEEE 1394b-2002 Standard, “IEEE Standard for a High Performance Serial Bus—Amendment 2,” published in 2002, and recent revisions. For more information regarding IEEE 802.11x (e.g., IEEE 802.11g) standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments/revisions.

Coupling the processors 122, 130 together in this fashion may allow the first processor 122 to operate the auxiliary display 118 as a proxy for the second processor 130. Thus, in some cases, graphics G generated by applications APPS executed by the second processor 130 can be displayed on the auxiliary display 118, as well as on the primary display 138, at substantially the same time, or at different times.

In some embodiments, the apparatus 100, perhaps taking the form of a mobile computing device, such as a personal digital assistant (PDA) or digital music player, can be inserted into and removed from a recessed housing compartment 142, including a purpose-built slot, of a desktop or notebook/laptop computer 134. When inserted, the apparatus 100 can run in conjunction with the second processor 130, perhaps obtaining power and data access from the computer 134. Power supplies PS, comprising batteries or alternating current supplies, or both, may be included in the apparatus 100, the computer 134, or both.

Thus, when inserted into the recessed housing compartment 142, the apparatus 100 can operate as an auxiliary display for the computer 134. Display applications include but are not limited to: email viewing, instant messaging, time-of-day and calendar reminders, system status information (e.g., battery charge condition and wired/wireless network connectivity), multimedia playback (e.g., photos, movies, music, network radio, rich site summary (RSS) feeds, and live television), transient information presentation (e.g., current news, sports, weather, stock quotes, horoscopes, lottery results, cinema and theater show times, auction status, package shipment status, and airplane flight status), document presentations, and slide shows. As mentioned previously, when removed from the recessed housing compartment 142, the apparatus 100 may operate as a stand-alone device.

If the computer 134 is in a power-off or sleep state, insertion into the recessed housing compartment 142 (perhaps in conjunction with user activation of a user input device 150 attached to the apparatus 100) can cause the computer 134 to boot up or wake up so that additional data DATA not cached in the apparatus 100 can be retrieved from the computer 134 (or from wired/wireless networks, not shown, to which the computer 134 is connected). When inserted into the recessed housing compartment 142, the memory 126 of the apparatus 100 may operate as part of a RAID volume set for the computer 134. In addition, upon insertion into, or warning of imminent removal from the recessed housing compartment 142 (e.g., responsive to activation of a user input device 150, or other controls 154 attached to the apparatus 100), automatic data DATA synchronization operations can be performed to maintain data consistency between the memory 158 in the computer 134 and the memory 162 in the apparatus 100. The recessed housing compartment 142 may be constructed so as to not protrude substantially beyond the outer contours of the computer 134.

When removed from the recessed housing compartment 142, the apparatus 100 may operate independently from the computer 134, perhaps performing any of the display and/or media player applications mentioned herein. In some embodiments, the apparatus 100 may execute a variety of operating systems, including but not limited to: Microsoft® Windows® embedded systems, such as embedded XP and Windows® CE; smart personal object technology and tiny common language routine (SPOT/TinyCLR); Java 2 Micro Edition (J2ME™); Wind River VxWorks, and Linux.

Applications APPS and associated data DATA may be cached in the apparatus 100 memories 126, 162 prior to removal. Thus, the apparatus 100 may be used as portable storage and transfer device for data DATA, including documents, and audio/video media files. Those of ordinary skill in the art and familiar with RAID operations will realize after reviewing this document that RAID backup operations may occur on a continuous basis between the apparatus 100 and the computer 134, so that no synchronization, as is commonly understood with respect to PDAs and the like, is needed. That is, RAID operations may be conducted so that selected data in the memories 126 and 144, for example, is constantly backed up. Thus, removing/inserting the apparatus 100 from/into the recessed housing compartment may not affect the accessibility of RAID data, either by the apparatus 100, or the computer 134.

In some embodiments, the apparatus 100 may operate as a multimedia player when coupled to or plugged into a vehicle (e.g., car, bicycle, motorcycle, boat, or plane) or home entertainment system. Thus, in some embodiments, the housing 114 may include a set of controls 154, including audio and/or video playback controls. For even greater versatility, the apparatus 100 may include one or more cameras 166 and/or one or more telephones 170 coupled to the first processor 122.

It should be noted that redundant array disk storage, as is included in some embodiments of the memories 126, 162, may operate according to a redundant array of inexpensive or independent disks (RAID) standard. Any system which operates to recombine physical disk space in an attempt to achieve improved reliability or performance is to be considered a redundant array disk storage for the purposes of this document.

A redundant array disk storage includes using multiple hard drives or memories for sharing or replicating data among the drives/memories, and combining multiple hard drives/memories into a single logical unit. For example, instead of of an operating system being able to access several physically separate hard drives, only one may be available as a logical unit in a redundant array disk storage system.

RAID standards can be implemented in dedicated hardware or custom software running on standard hardware. Additionally, hybrid RAID systems that are partly software and partly hardware maybe used. The memories 126, 144 of the apparatus 100 may therefore form a portion of a RAID volume set included in the computer 134.

With a software implementation, the operating system may manage some of the disks 162 of the redundant array through a drive controller 172 (e.g., SATA, integrated disk electronics (IDE), small computer serial interface (SCSI), and others). In some cases, software RAID can be faster than hardware RAID, though at the cost of using CPU power which might be best used for other tasks.

The original RAID specification suggested a number of prototype RAID Levels, or combinations of disks. Other specifications may have been implemented since that time. For more information on the original RAID specification, please see “A Case for Redundant Arrays of Inexpensive Disks (RAID),” Conference Proceedings of the Special Interest Group on the Management Of Data (SIGMOD), pgs. 109-116, 1988, as well as more recent articles.

Thus many embodiments may be realized. For example, the apparatus 100 may include a user input device 150 attached to the housing 114, perhaps coupled to the first processor 122 and the second processor 130. The memories 126, 162 and/or the first processor 122 of the apparatus 100 may include one or more application caches CACHE to store applications APPS to be executed by the first processor 122.

Referring now to FIGS. 1B-1D, some of the physical characteristics of the apparatus 100 and systems 110 may be observed. For example, in some embodiments, no more than four faces of the housing 114 are visible when the housing 114 is received by the recessed housing compartment 142. This situation may include visibility of the top, front, and two side faces. Thus, the recessed housing compartment 142 may include an aperture 174 to expose no more than four faces of the housing 114 after the housing 114 is received by the recessed housing compartment 142.

In some embodiments, only three faces may be visible (e.g., top, front, and one side) after the housing 114 is received by the recessed housing compartment 142. In some embodiments, only two faces may be visible (e.g., top and front, as shown in FIG. 1B). In some embodiments, only one face may be visible (e.g., front face only).

In some cases, it is possible that the form factor of the computer 134 may remain substantially unchanged after the housing 114 is received by the recessed housing compartment 142, as shown in FIG. 1B. For the purposes of this document, the form factor of the computer 134 remains “substantially unchanged” if, after receiving the apparatus 100 into the recessed housing compartment 142, the outer dimensions of the computer 134 are substantially the same as they were prior to receipt of the apparatus 100 into the recessed housing compartment 142.

Other embodiments may be realized. For example, as seen in FIGS. 1A-1D, a system 110 may include one or more apparatus 100, as described above. The system 110 may also include a computer 134, such as a desktop or portable (laptop/notebook) computer, having an integrated primary display 138 and a recessed housing compartment 142. The system 110 may include a detection module DET to detect reception of the housing 114 by the recessed housing compartment 142 and to initiate responsive activity by the first processor 122, the second processor 130, or both.

For increased versatility, the system 110 may include one or more antennas 182 to receive a portion of the data DATA included in the memory 158 from a wireless network. In some embodiments, the system 110 may include an image projector 186 coupled to the second processor 130, perhaps via the use of a graphics/memory controller.

Any of the components previously described can be implemented in a number of ways, including simulation via software. Thus, the apparatus 100; systems 110; housing 114; auxiliary display 118; processor 122, 130; memories 126, 144, 158, 162; computer 134; primary display 138; recessed housing compartment 142; switch 148; user input device 150; bridge 152; cameras 166; telephones 170; controller 172; caches CACHE; antennas 182; image projector 186; applications APPS; bus BUS; bus controller 146; controls 154; data DATA; graphics G; ports PORT1, PORT2; and power supplies PS may all be characterized as “modules” herein.

Such modules may include hardware circuitry, single and/or multi-processor circuits, memory circuits, software program modules and objects, and/or firmware, and combinations thereof, as desired by the architect of the apparatus 100 and systems 110, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, and/or a combination of software and hardware used to operate, or simulate the operation of various potential embodiments.

It should also be understood that the apparatus and systems of various embodiments can be used in applications other than portable computers and media players, and thus, various embodiments are not to be so limited. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single and/or multi-processor modules, single and/or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

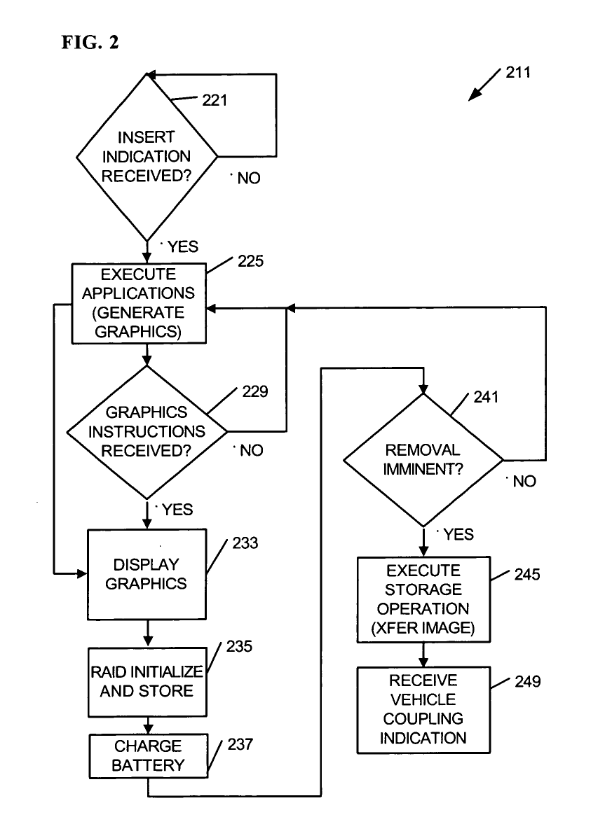

Some embodiments may include a number of methods. For example, FIG. 2 is a flow diagram illustrating several methods 211 according to various embodiments of the invention. A method 211 may include receiving an indication that the housing of the apparatus described above has been inserted into the recessed housing compartment of a computer at block 221. If the indication is received, then the method 211 may include executing one or more applications on the apparatus, the computer, or both. Thus, the method 211 may also include executing a storage operation using redundant array disk storage at block 245, perhaps in response to receiving the insertion indication.

Executing the applications may include the generation of graphics at block 225. The applications and graphics may include any type of applications and graphics which can be processed by a computer. For example, the application may comprise an email program or a network browser, and the graphics may comprise a email in-box listing or a portion of a web page, respectively.

The method 211 may include direct display of the generated graphics on the auxiliary display of the apparatus at block 233. However, in some embodiments, if instructions selected from hypertext markup language (HTML), extensible markup language (XML), or device context drawing functions are received at the processor included in the housing from the processor included in the computer (e.g., a portable computer) at block 229, then the graphics may be displayed on the auxiliary display in response to receiving the instructions at block 233. The method 211 may include initializing and conducting RAID system storage operations at block 235. Some embodiments of the method 211 include charging a battery included in the housing using power supplied by the computer that has received it at block 237.

Upon receiving an indication that the housing is to be removed from the recessed housing compartment at block 241, the method 211 may include synchronizing files or data, or executing a storage operation using redundant array disk storage at block 245, as described previously. For example, the method 211 may include transferring an image from the memory of the apparatus to the computer in response to receiving the indication that removal is imminent. As part of providing even greater versatility, the method 211 may include receiving an indication that a port included in the housing has been coupled to a port included in a vehicle at block 249 (e.g., the indication may be received by the first processor 122 of FIG. 1A).

It should be noted that the methods described herein do not have to be executed in the order described, or in any particular order. Moreover, various activities described with respect to the methods identified herein can be executed in repetitive, simultaneous, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including HTML and XML.

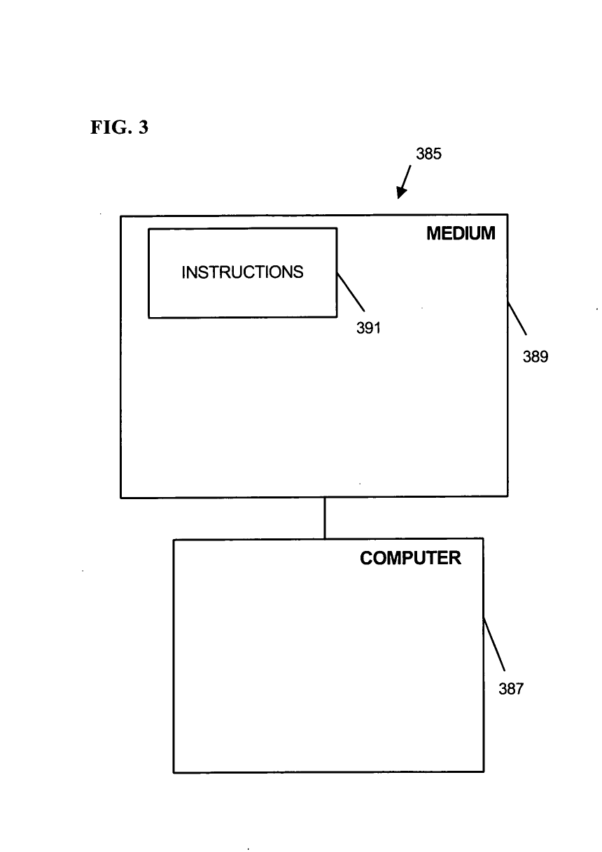

Thus, other embodiments may be realized. For example, FIG. 3 is a block diagram of an article 385 according to various embodiments, such as a computer, a memory system, a magnetic or optical disk, some other storage device, and/or any type of electronic device or system. The article 385 may include a computer 387 (having one or more processors) coupled to a computer-readable medium 389, such as a memory (e.g., fixed and removable storage media, including tangible memory having electrical, optical, or electromagnetic conductors) or a carrier wave, having associated information 391 (e.g., computer program instructions and/or data), which when executed by the computer 387, causes the computer 387 to perform a method including receiving an indication that a housing having an integrated auxiliary display and a memory forming a portion of a redundant array disk storage has been inserted into a recessed housing compartment of a portable computer having an integrated primary display.

Further activities may include executing a storage operation using the redundant array disk storage, perhaps in response to receiving the indication that the housing has been inserted into the recessed housing compartment. Other activities may include displaying graphics on the auxiliary display in response to receiving instructions selected from one of HTML, XML, or a device context drawing function at a first processor included in the housing from a second processor included in the portable computer. In some embodiments, the activities may include charging a battery included in the housing using power supplied by the portable computer. Additional activities may include any of those forming a portion of the methods illustrated in FIG. 2 and described above.

Implementing the apparatus, systems, and methods disclosed herein may provide automatic synchronization of data, perhaps using RAID standard operations between the apparatus described herein and portable computers, without the use of bulky docking stations and cables. Multiple apparatus may be swapped or rotated to provide a sequence of backups over time. Further advantages may include the provision of an interactive auxiliary display that users can carry on-the-go, and use to view cached information, or to enjoy multimedia playback apart from a desktop or portable computer. Finally, some embodiments may provide virtually “instant-on” capability, with automated sensing by the computer when the apparatus is received by the recessed housing compartment.

Although the inventive concept may be described in the exemplary context of an 802.xx implementation (e.g., 802.3ab, 802.11a, 802.11g, 802.11HT, 802.11k, 802.16, 802.20, etc.), the claims are not so limited. Embodiments of the present invention may well be implemented as part of any wired or wireless system. Examples may also include embodiments comprising multi-carrier wireless communication channels (e.g., orthogonal frequency-division multiplexing (OFDM), discrete multi-tone modulation (DMT), etc.) such as may be used within a wireless personal area network (WPAN), a wireless local area network (WLAN), a wireless metropolitan area network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, including:
a housing having an integrated auxiliary display coupled to a first processor coupled to a memory and
a port included in the housing to couple the first processor to a second processor included in a portable computer having an integrated primary display and a recessed housing compartment to receive the housing, wherein the memory is to form a portion of a redundant array disk storage when the first processor is coupled to the second processor.

2. The apparatus of claim 1, wherein the first processor is to operate the auxiliary display as a proxy for the second processor.

3. The apparatus of claim 1, wherein graphics generated by an application executed by the second processor can be displayed on the auxiliary display.

4. The apparatus of claim 1, further comprising:
a user input device to couple to the first processor and the second processor, wherein the user input device is attached to the housing.

5. The apparatus of claim 1, wherein the redundant array disk storage operates according to a redundant array of independent disks standard.

6. The apparatus of claim 1, wherein the memory comprises a non-volatile memory.

7. The apparatus of claim 1, wherein the memory is to form a portion of a redundant array of independent disks volume set included in the portable computer.

8. The apparatus of claim 1, further including:
a camera coupled to the first processor.

9. The apparatus of claim 1, wherein no more than four faces of the housing are visible when the housing is received by the recessed housing compartment.

10. The apparatus of claim 1, wherein a form factor of the portable computer is substantially unchanged when the housing is received by the recessed housing compartment.

11. The apparatus of claim 10, further including:
a telephone coupled to the first processor.

12. The apparatus of claim 10, wherein the housing further includes:
a set of video playback controls.

13. A system, including:
a portable computer having an integrated primary display and a recessed housing compartment; and
a housing having an integrated auxiliary display coupled to a first processor coupled to a memory, and a port included in the housing to couple the first processor to a second processor included in the portable computer, wherein the recessed housing compartment is to receive the housing, and wherein the memory is to form a portion of a redundant array disk storage when the first processor is coupled to the second processor.

14. The system of claim 13, wherein the recessed housing compartment further includes:
an aperture to expose no more than four faces of the housing after the housing is received by the recessed housing compartment.

15. The system of claim 13, further including:
a detection module to detect reception of the housing by the recessed housing compartment and to initiate responsive activity by one of the first processor or the second processor.

16. The system of claim 13, further including:
an antenna to receive a portion of data included in the memory from a wireless network.

17. The system of claim 13, wherein the port comprises one of a serial port, a parallel port, a wired network interface, an optical interface, or a wireless network interface.

18. The system of claim 13, further including:
an image projector coupled to the second processor.

19. A method, including:
receiving an indication that a housing having an integrated auxiliary display and a memory forming a portion of a redundant array disk storage has been inserted into a recessed housing compartment of a portable computer having an integrated primary display; and
executing a storage operation using the redundant array disk storage.

20. The method of claim 19, wherein executing the storage operation further includes:
transferring an image from the memory to the portable computer in response to receiving the indication.

21. The method of claim 19, further including:
receiving an indication that the housing has been removed from the recessed housing compartment.

22. The method of claim 19, further including:
executing an application by the portable computer to generate graphics; and
displaying the graphics on the auxiliary display.

23. The method of claim 22, wherein the application comprises a network browser, and wherein the graphics comprise a portion of a web page.

24. The method of claim 19, further including:
receiving an indication that a port included in the housing has been coupled to a port included in a vehicle.

25. A computer-readable medium having instructions stored thereon which, when executed by a computer, cause the computer to perform a method comprising:
receiving an indication that a housing having an integrated auxiliary display and a memory forming a portion of a redundant array disk storage has been inserted into a recessed housing compartment of a portable computer having an integrated primary display; and
executing a storage operation using the redundant array disk storage.

26. The article of claim 25, wherein the instructions, when executed by the computer, cause the computer to perform a method comprising:
displaying graphics on the auxiliary display in response to receiving instructions selected from one of hypertext markup language, extensible markup language, or a device context drawing function at a first processor included in the housing from a second processor included in the portable computer.

27. The article of claim 25, wherein the instructions, when executed by the computer, cause the computer to perform a method comprising:
charging a battery included in the housing using power supplied by the portable computer.
